(19) United States
(12) Patent Application Publication
(10) Pub. No.: US 2026/0336030 A1
(43) Pub. Date: Oct. 29, 2026

(54) APPARATUS AND METHOD FOR LASER WIRE WELDING

(71) Applicant: SK On Co., Ltd., Seoul (KR)

(72) Inventors: Kyung Min LEE, Daejeon (KR); Kwan Yong KIM, Daejeon (KR); Wook Hyun KIM, Daejeon (KR); Tae Hyun KIM, Daejeon (KR); So Jeong PARK, Daejeon (KR); Dong Hun LEE, Daejeon (KR); Eui Seob LEE, Daejeon (KR)

(21) Appl. No.: 19/567,268

(22) Filed: Mar. 16, 2026

(30) Foreign Application Priority Data
Apr. 23, 2025 (KR) 10-2025-0053199

(51) Int. Cl. B23K 26/24; B23K 26/03; B23K 37/02; G06T 7/00; G06T 7/50

(52) U.S. Cl. CPC B23K 26/24; B23K 26/032; B23K 37/0229; G06T 7/001; G06T 7/50; G06T 2207/20081; G06T 2207/30136

(57) ABSTRACT

Proposed are an apparatus and a method for laser wire welding. The apparatus includes a welding robot movable and outputting a laser for performing cutting of a welding wire in addition to performing welding of a target to be welded, a wire feeder for transporting and supplying the welding wire, which is melted by the laser supplied by the welding robot to enable welding at a welding portion of the target to be welded, to protrude by a predetermined length from an end of a wire tip, a camera for acquiring an image of the welding wire, and a controller for receiving the image of the welding wire from the camera, for determining a cutting state of the welding wire on the basis of the image, and for controlling the welding robot to perform welding when the cutting state of the welding wire is determined to be acceptable.

### CROSS REFERENCE TO RELATED APPLICATION

The present application claims priority to Korean Patent Application No. 10-2025-0053199, filed on Apr. 23, 2025, the entire contents of which are incorporated herein for all purposes by this reference.

### TECHNICAL FIELD

The present disclosure relates to an apparatus and a method for laser wire welding using a welding wire.

### BACKGROUND

In general, welding technology is widely applied in assembly processes in manufacturing fields such as batteries, automobiles, and electronic devices.

Welding technology is a technique for fusing or joining components by using energy as a heat source, and a laser welding method, which uses a laser as the heat source, is cited as one example. For laser welding, a welding robot is used for automation, and exhibits advantages of high precision and repeatability.

In laser welding, a welding wire may be used together in order to secure welding quality depending on the material of a target to be welded. The composition used the welding wire may vary depending on the material of the target to be welded. The diameter of the welding wire may vary depending on a welding method such as teach-in or seam tracking. Welding quality may vary depending on the material of the welding wire and the welding method.

In addition, when the welding wire is used together in performing laser welding, it is essential to manage a length and shape protruding from an end of a wire tip. The length and shape of the welding wire protruding from the end of the wire tip can have a significant impact on securing uniform welding quality.

### SUMMARY

According to one aspect of the present disclosure, there is provided an apparatus and a method for laser wire welding, which is capable of performing non-contact cutting of a welding wire in addition to performing welding of a target to be welded using a laser.

An apparatus and a method for laser wire welding according to one aspect of the present disclosure may be widely applied to green technologies such as electric vehicles, battery charging stations, and other solar power generation and wind power generation using batteries.

An apparatus and a method for laser wire welding according to one aspect of the present disclosure may be applied to eco-friendly electric vehicles, hybrid vehicles, and the like for preventing climate change by suppressing air pollution and greenhouse gas emissions.

A laser wire welding apparatus according to one aspect of the present disclosure includes a welding robot movable and outputting a laser for performing cutting of a welding wire in addition to performing welding of a target to be welded, a wire feeder for transporting and supplying the welding wire, which is melted by the laser supplied by the welding robot to enable welding at a welding portion of the target to be welded, to protrude by a predetermined length from an end of a wire tip, a camera for acquiring an image of the welding wire, and a controller for receiving the image of the welding wire from the camera, for determining a cutting state of the welding wire on the basis of the image, and for controlling the welding robot to perform welding when the cutting state of the welding wire is determined to be acceptable.

According to an exemplary embodiment, the controller may control the welding robot to perform cutting when the cutting state of the welding wire is determined to be defective.

According to an exemplary embodiment, the welding robot may include a movable body configured to be movable, a multi-joint robot arm coupled to the movable body, and a laser output device coupled to an end of the multi-joint robot arm and outputting the laser for performing welding of the target to be welded or for performing cutting of the welding wire.

According to an exemplary embodiment, the laser output device may be controlled to have a lower laser intensity and a shorter laser irradiation time when performing cutting of the welding wire than when outputting the laser for performing welding.

According to an exemplary embodiment, the controller may measure a shape of the welding wire from the image of the welding wire received from the camera, and determine the cutting state of the welding wire as acceptable or defective by comparing the measured shape with a preset reference value.

According to an embodiment, the controller may input the image of the welding wire received from the camera into a state determination model, and the state determination model may determine the cutting state of the welding wire as acceptable or defective, wherein the state determination model is an artificial intelligence model trained using a training data set in which the images of the welding wire are training data and acceptable or defective determinations are label data.

According to an exemplary embodiment, the shape of the welding wire may include at least one of an inclination, a length, and a diameter of the welding wire.

According to an exemplary embodiment, the length of the welding wire may be a distance from the end of the wire tip to the end of the welding wire in contact with the target to be welded, the inclination of the welding wire may be an angle formed between a centerline of a diameter of the wire tip and a line connecting a center of the diameter of the welding wire to a center of the end of the wire tip, and the diameter of the welding wire may be a straight line passing through a center of a circle, which is an upper limit of a length of a line segment connecting two points on the circumference.

A method for laser wire welding according to one aspect of the present disclosure includes transporting a welding wire to protrude by a predetermined length from an end of a wire tip by driving a wire feeder, cutting the welding wire by a welding robot outputting a laser, acquiring an image by a camera capturing the welding wire on which laser cutting is performed, determining, by a controller, an cutting state of the welding wire as acceptable or defective on the basis of the image after receiving the image of the welding wire from the camera, and controlling, by the controller, the welding robot to perform welding when the cutting state of the welding wire is determined to be acceptable.

According to an exemplary embodiment, when it is determined to be defective in the cutting state determination step, feeding back to the wire transport step may be included.

According to an exemplary embodiment, the cutting state determination step may include measuring a shape of the welding wire in the received image of the welding wire, and determining the cutting state of the welding wire as acceptable or defective by comparing the measured shape of the welding wire with a preset reference value, wherein the shape of the welding wire comprises at least one of an inclination, a length, and a diameter of the welding wire.

According to an exemplary embodiment, the cutting state determination step may include inputting the received image of the welding wire into a state determination model by the controller, and determining the cutting state of the welding wire as acceptable or defective by the state determination model on the basis of the image, wherein the state determination model is an artificial intelligence model trained using a training data set in which the images of the welding wire are training data and acceptable/defective determinations are label data.

According to an exemplary embodiment, the method may further include determining a state of the welding wire while performing the welding step, wherein the in-welding wire state determination step includes receiving, by the controller, the image of the welding wire, which is in contact with an output laser, from the camera while welding is being performed, calculating, by the controller, an overlapping region in which the output laser is emitted onto the welding wire on the basis of the received image, determining, by the controller, the state of the welding wire as defective when the calculated value of the overlapping region in which the output laser is emitted onto the welding wire deviates from a reference value, and stopping performing welding by the controller to feedback to the wire transport step.

The features and advantages of the present disclosure will become more apparent from the following detailed description with reference to the accompanying drawings.

The terms and words used in the present specification and the claims should not be construed as having ordinary or dictionary meanings, but should be interpreted as meanings and concepts consistent with the technical spirit of the present disclosure, on the basis of the principle that the inventor may appropriately define the concepts of terms in order to describe his or her invention in the best way.

According to an exemplary embodiment of the present disclosure, it is possible to perform non-contact cutting of a welding wire in addition to performing welding using a single laser output from a welding robot.

According to an exemplary embodiment of the present disclosure, it is possible to perform a cutting process of a welding wire at a place where welding is performed without moving a position of a welding robot.

According to an exemplary embodiment of the present disclosure, it is possible to manage an end of a welding wire uniformly.

According to an exemplary embodiment of the present disclosure, it is possible to secure uniform welding quality.

According to an exemplary embodiment of the present disclosure, it is possible to increase a production speed during laser welding using a welding wire.

### BRIEF DESCRIPTION OF THE DRAWINGS

FIG. 1 is a view illustrating a laser wire welding apparatus according to an exemplary embodiment.

FIG. 2 is a view illustrating a controller in a laser wire welding apparatus according to an exemplary embodiment.

FIG. 3 is a view illustrating a welding wire in a region protruding from a wire tip in a laser wire welding apparatus according to an exemplary embodiment.

FIG. 4 is a view illustrating a controller including a state determination model in a laser wire welding apparatus according to an exemplary embodiment.

FIG. 5 is a view illustrating a usage state of a state determination model in a laser wire welding apparatus according to an exemplary embodiment.

FIG. 6 is a view illustrating a process of generating a state determination model in a laser wire welding apparatus according to an exemplary embodiment.

FIG. 7 is a view illustrating a training data set used for generating a state determination model in a laser wire welding apparatus according to an exemplary embodiment.

FIG. 8 is a view illustrating a laser wire welding method according to an exemplary embodiment.

FIG. 9 is a view illustrating a cutting state determination step in a laser wire welding method according to an exemplary embodiment.

FIG. 10 is a view illustrating a cutting state determination step using a state determination model in a laser wire welding method according to an exemplary embodiment.

FIG. 11 is a view including an in-welding wire state determination step in a laser wire welding method according to an exemplary embodiment.

FIG. 12 is a view illustrating an in-welding wire state determination step in a laser wire welding method according to an exemplary embodiment.

FIG. 13 is a view illustrating an acceptable or defective determination in an in-welding wire state determination step in a laser wire welding method according to an exemplary embodiment.

FIG. 14 is a view illustrating a design shape of welding that can be performed through a laser wire welding apparatus and method according to an exemplary embodiment.

### DETAILED DESCRIPTION

Hereinafter, the present disclosure will be described in detail (with reference to the accompanying drawings). However, this may be only illustrative, and the present disclosure is not limited to the specific exemplary embodiments described as examples.

The drawings may be displayed schematically or in an exaggerated manner for the purpose of explaining the exemplary embodiments.

In this document, expressions such as “may include” and “may have” may indicate the presence of a corresponding feature (e.g., numerical values, functions, operations, or parts as components) and may not preclude the presence of additional features.

Hereinafter, an exemplary embodiment of the present disclosure will be described in detail with reference to the accompanying drawings.

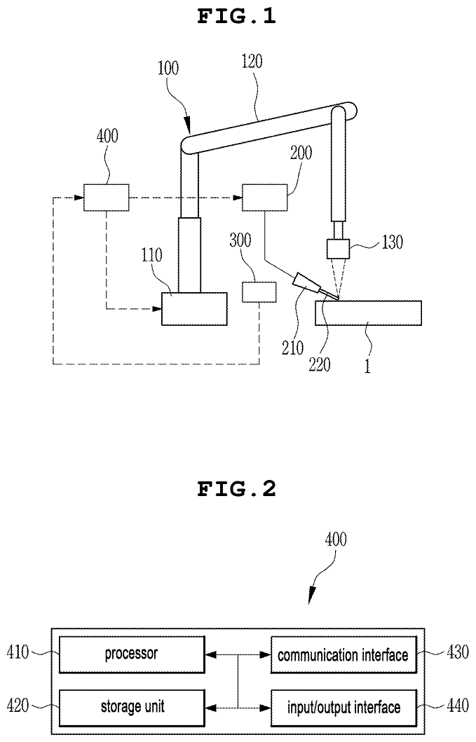

FIG. 1 is a view illustrating a laser wire welding apparatus according to an exemplary embodiment, and FIG. 2 is a view illustrating a controller in a laser wire welding apparatus according to an exemplary embodiment.

Referring to FIGS. 1 and 2, the laser wire welding apparatus according to the present disclosure may include a welding robot 100 movable and outputting a laser for performing cutting of a welding wire 220 in addition to performing welding of a target 1 to be welded, a wire feeder 200 for transporting and supplying the welding wire 220, which is melted by the laser supplied by the welding robot 100 to enable welding at a welding portion of the target 1 to be welded, to protrude by a predetermined length from an end of a wire tip 210, a camera 300 for acquiring an image of the welding wire 220, and a controller 400 for receiving the image of the welding wire 220 from the camera 300, for determining a cutting state of the welding wire 220 on the basis of the image, and for controlling the welding robot 100 to perform welding when the cutting state of the welding wire 220 is determined to be acceptable.

The target to be welded 1 may be a component used in various industrial fields including batteries, automobiles, home appliances, ships, and the like. The target to be welded 1 may be a component used in all industrial fields in which laser wire welding is applicable. The target 1 to be welded may be made of a ferrous metal material or a non-ferrous metal material.

In the target 1 to be welded, examples of components applied to welding for each type of battery in the battery industry may be as follows.

In the case of a pouch cell, the target 1 to be welded may be a component applied to “foil-tab welding” in a battery assembly process. The target 1 to be welded may be an electrode including a positive electrode and a negative electrode, which are thin films in the form of foil, and a tab connected to the electrode to concentrate the flow of current into one place.

In the case of a pouch module, the target 1 to be welded may be a component applied to “tab-busbar welding” in a battery assembly process. The target 1 to be welded may be a tab connected to the electrode including a positive electrode and a negative electrode to concentrate the flow of current into one place, and a busbar to electrically connect the tabs.

In addition, the target 1 to be welded may be a component applied to “case welding” in a battery assembly process. The target 1 to be welded may be a case for protecting a modularized pouch cell.

In the case of a prismatic cell, the target 1 to be welded may be a component applied to “foil-CC welding” in the battery assembly process. The target 1 to be welded may be an electrode including a positive electrode and a negative electrode, which are thin films in the form of foil, and a current collector (CC) having a busbar function that electrically connects the electrodes.

In addition, the target 1 to be welded may be a component applied to “cap-CC welding” in a battery assembly process. The target 1 to be welded may be a cap for sealing an upper portion of a can that protects a battery cell, and a current collector for performing a busbar function.

In addition, the target 1 to be welded may be a component applied to “can-cap welding” in a battery assembly process. The target 1 to be welded may be a can for protecting a battery cell and a cap for sealing an upper portion of the can.

In addition, the target 1 to be welded may be a component applied to “seal cover welding” in a battery assembly process. The target 1 to be welded may be a seal cover for blocking an electrolyte injection hole after electrolyte is injected into a battery cell.

In the case of a cylindrical cell, the target 1 to be welded may be a component applied to “J/R-CC welding” or “J/R-cap welding” in a battery assembly process. The target 1 to be welded may be a jelly roll (J/R) having a structure in which a negative electrode, a separator, and a positive electrode are laminated and then rolled up, and a current collector for performing a busbar function. The target 1 to be welded may be a jelly roll (J/R) having a structure in which a negative electrode, a separator, and a positive electrode are laminated and then rolled up, and a cap for sealing an upper portion of the can protecting the battery cell.

In addition, the target 1 to be welded may be a component applied to “CC-can welding” in a battery assembly process. The target 1 to be welded may be a current collector for performing a busbar function and a can for protecting the battery cell.

In addition, the target 1 to be welded may be a component applied to “can-cap welding” in a battery assembly process. The target 1 to be welded may be a can for protecting a battery cell and a cap for sealing an upper portion of the can.

In addition, the target 1 to be welded may be a component applied to “seal cover welding” in a battery assembly process. The target 1 to be welded may be a seal cover for blocking an electrolyte injection hole after electrolyte is injected into a battery cell.

The welding robot 100 may have a movable robot-type structure. The welding robot 100 may perform welding on the target 1 to be welded or cut the end portion of the welding wire 220 through laser output. The laser output from the welding robot 100 may vary depending on whether welding or cutting is performed. The laser output may be adjusted by the controller 400.

The welding robot 100 may include a movable body 110 configured to be movable, a multi-joint robot arm 120 coupled to the movable body 110, and a laser output device 130 coupled to the end of the multi-joint robot arm 120 and outputting a laser for performing welding of the target 1 to be welded or for performing cutting of the welding wire 220.

The welding robot 100 may perform a welding process on the target 1 to be welded or may perform a cutting process on the welding wire 220 using a single laser output from the laser output device 130.

The movable body 110 may be in a form capable of freely moving in position. The multi-joint robot arm 120 may be in a form capable of moving in multiple directions. The laser output device 130 may have the intensity and irradiation time of the output laser adjusted by the controller 400. When performing cutting of the welding wire 220, the laser output device 130 may be controlled to have a lower laser intensity and a shorter laser irradiation time than when outputting a laser for performing welding.

The wire feeder 200 may be installed on the welding robot 100. The wire feeder 200 may be a roller-type body for supplying the welding wire 220, and may include a wire tip 210. The wire tip 210 may support an end portion of the welding wire 220 supplied through the wire feeder 200. The wire tip 210 may be installed on the welding robot 100. The wire tip 210 may be installed to be position-adjustable. The welding wire 220 may be supplied through the wire feeder 200 and may protrude by a predetermined length while the end portion is supported by the wire tip 210. The end of the welding wire 220 may be in contact with the welding area of the target 1 to be welded and may be melted by the heat source of the laser emitted from the laser output device 130, thereby supporting welding.

The camera 300 may acquire an image by capturing the welding wire 220 having a region that protrudes by a predetermined length while being supported by the wire tip 210. The camera 300 may be installed on the welding robot 100. The camera 300 may transmit, to the controller 400, image information obtained by capturing the end portion of the welding wire 220.

The controller 400 may include a processor 410 and a storage unit 420 communicatively connected to the processor 410 to transmit and receive data. The storage unit 420 may store program codes for performing laser welding or cutting of the welding wire, and other necessary data. The processor 410 may be operated by the program code stored in the storage unit 420. The controller 400 may further include a communication interface 430 for communication and an input/output interface 440 for input/output of data. The communication interface 430 may receive image information from the camera 300.

The controller 400 may check the cutting state of the end portion protruding from the wire tip 210 by a predetermined length. When the cutting state of the welding wire 220 is determined to be defective, the controller 400 may control the welding robot 100 to perform cutting.

When performing cutting of the welding wire 220, the controller 400 may control the welding robot 100 and adjust a laser output of the laser output device 130. The laser output may be differently adjusted depending on a material, a diameter, and a welding method of the welding wire 220. In order to secure cutting quality of the welding wire 220, the laser output may be controlled to have an intensity of 1 kW to 4 kW and an irradiation time of 0.5 seconds or less. The welding wire 220 may be cut by instantaneously melting and vaporizing the cutting portion of the welding wire 220 through the laser output.

Parameters and cutting conditions for performing laser cutting of the welding wire 220 will be described as follows.

In order to manage the end quality of the welding wire 220, the controller 400 may control the laser output device 130 to adjust a laser intensity and an irradiation time according to a material, a diameter, and a welding method of the welding wire 220 when performing laser cutting.

When the target 1 to be welded is made of an aluminum-based non-ferrous metal and a teach-in welding method is applied, the welding wire 220 may be made of an aluminum (Al)-or copper (Cu)-based material and may have a diameter of 1.2 mm or greater. In this case, the laser output may be controlled to have an intensity of 1 kW to 4 kW and an irradiation time of 0.1 seconds to 0.5 seconds.

When the target 1 to be welded is made of a copper-based non-ferrous metal and a seam tracking welding method is applied, the welding wire 220 may be made of an aluminum (Al)-or copper (Cu)-based material and may have a diameter of about 0.5 mm to 1.1 mm. In this case, the laser output may be controlled to have an intensity of 1 kW to 4 kW and an irradiation time of 0.1 seconds to 0.3 seconds.

When the target 1 to be welded is a carbon steel-based ferrous metal and a teach-in welding method is applied, the welding wire 220 may be made of an iron (Fe)-based material and may have a diameter of 0.8 mm or greater. In this case, the laser output may be controlled to have an intensity of 1 kW to 4 kW and an irradiation time of 0.1 seconds to 0.5 seconds.

When the target 1 to be welded is a stainless steel-based ferrous metal and a seam tracking welding method is applied, the welding wire 220 may be made of an iron (Fe)-based material and may have a diameter of 0.8 mm or greater. In this case, the laser output may be controlled to have an intensity of 1 kW to 4 kW and an irradiation time of 0.1 seconds to 0.5 seconds.

In this way, when cutting of the welding wire 220 is to be performed, welding may be stopped when welding is in progress, and the controller 400 may control the multi-joint robot arm 120 of the welding robot 100 to adjust an irradiation direction of the laser output device 130. Interference with the target 1 to be welded may be prevented. For example, the controller 400 may control the multi-joint robot arm 120 of the welding robot 100 to tilt or move the laser output device 130 upward from the current welding position. In this case, the position of the welding wire 220 may also be adjusted.

Accordingly, in the present disclosure, a single laser output from the laser output device 130 in the welding robot 100 may be used to perform non-contact cutting of the welding wire 220 in addition to performing welding of the target 1 to be welded. In the present disclosure, the cutting process of the welding wire may be performed at a position where welding is performed without moving the position of the welding robot 100.

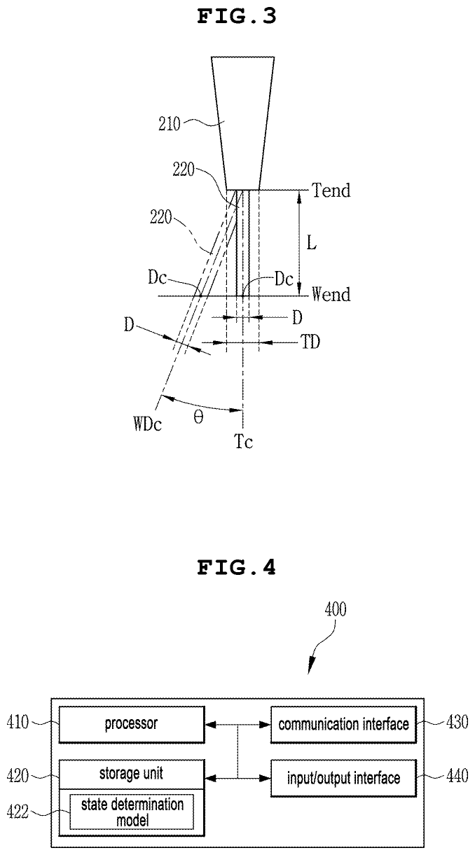

FIG. 3 is a view illustrating a welding wire in a region protruding from a wire tip in a laser wire welding apparatus according to an exemplary embodiment. FIGS. 1 and 2 are referred to together.

Referring to FIGS. 1 to 3, the controller 400 in the present disclosure may measure the shape of the welding wire 220 in the image of the welding wire received from the camera 300 and determine the cutting state of the welding wire 220 as acceptable or defective by comparing the measured shape with a preset reference value.

The controller 400 may receive image information of the welding wire 220 from the camera 300 through the communication interface 430. The processor 410 may be operated by the program code stored in the storage unit 420 to measure the shape of the welding wire 220 from the received image of the welding wire 220.

The shape of the welding wire 220 may include at least one of an inclination (θ), a length (L), and a diameter (D) of the welding wire 220.

The controller 400 may measure at least one of an inclination (θ), a length (L), and a diameter (D) of the welding wire 220. The controller 400 may measure each of the inclination (θ), the length (L), and the diameter (D) of the welding wire 220.

Referring to FIG. 3, the length (L) of the welding wire 220 may a distance from the end (Tend) of the wire tip 210 to the end (Wend) of the welding wire 220 that contacts the target 1 to be welded, the inclination (θ) of the welding wire 220 may be an angle formed between a centerline (Tc) of a diameter (TD) of the wire tip 210 and a line (WDc) connecting a center (Dc) of a diameter (D) of the welding wire 220 to a center of the end (Tend) of the wire tip 210, and the diameter (D) of the welding wire 220 may be a straight line passing through the center of the circle and may be the upper limit of the length of a line segment connecting two points on the circumference.

The controller 400 may measure at least one of the inclination (θ), the length (L), and the diameter (D) of the end portion of the welding wire 220 and compare the measured value with the preset reference value. When each measured value is greater than the reference value, the controller 400 may determine the cutting state of the welding wire 220 to be acceptable. When each measured value is less than the reference value, the controller 400 may determine the cutting state of the welding wire 220 to be defective.

When the cutting state of the welding wire 220 is determined to be defective, the controller 400 may control the welding robot 100 to perform the cutting process on the end portion of the welding wire 220. Such a cutting process of the welding wire 220 may equally utilize the laser output of the welding robot 100. When performing cutting of the welding wire 220, the controller 400 may control differently from the laser output for performing welding. When performing cutting of the welding wire 220, the controller 400 may control the laser output device 130 to adjust the laser intensity and the laser irradiation time to be lower than the laser output for performing welding.

When cutting the welding wire 220, the controller 400 may instantaneously melt and vaporize the cutting portion of the welding wire 220 through laser output. In order to secure cutting quality of the welding wire 220, the laser output may be controlled to have an intensity of 1 kW to 4 kW and an irradiation time of 0.5 seconds or less.

As described above, when the cutting status of the welding wire 220 is checked and determined to be acceptable in the present disclosure, welding can be performed on the target 1 to be welded. In addition, when the cutting state of the welding wire 220 is determined to be defective, cutting of the welding wire 220 may be performed, and the cutting may be re-performed through feedback.

Accordingly, in the present disclosure, the end of the welding wire 220 may be uniformly managed. In the present disclosure, the shape of the welding wire 220 may be uniformly managed, such that the welding quality for the welding area may be uniformly secured.

In particular, in the present disclosure, when cutting of the welding wire 220 is performed, the laser output from the welding robot 100 may be directly utilized, so the cutting process can be performed without moving the position of the welding robot 100. That is, the present disclosure may provide an advantage of being able to immediately switch to the cutting process even while performing the welding process at the welding position.

Hereinafter, a conventional cutting process of a welding wire 220 will be schematically described for comparison, as follows.

Conventionally, physical cutting has mostly been performed using a cutting tool. Such a physical cutting method has a hassle of having to move the position of the welding robot toward the cutting tool and returning to the welding position where the target to be welded is present. That is, losses in welding operations occurred due to the movement and return of the welding robot, resulting in a decrease in production speed and thus reduced productivity. In addition, conventionally, it has been difficult to uniformly manage a cutting portion of the welding wire.

In contrast, in the present disclosure, it is possible to perform the cutting process of the welding wire 220 in addition to performing welding for the target 1 to be welded at the same position without positional movement of the welding robot 100. Positional movement of the welding robot 100 may be eliminated even during a process transition in the field, thereby preventing losses in welding operations. In addition, in the present disclosure, feedback control may be performed through acceptable or defective determination during cutting of the welding wire 220, so that the end of the welding wire 220 can be managed uniformly.

Accordingly, the present disclosure may perform welding while uniformly managing the end of the welding wire 220, thereby securing uniform welding quality. In the present disclosure, it is possible to increase the production speed during laser welding using the welding wire 220.

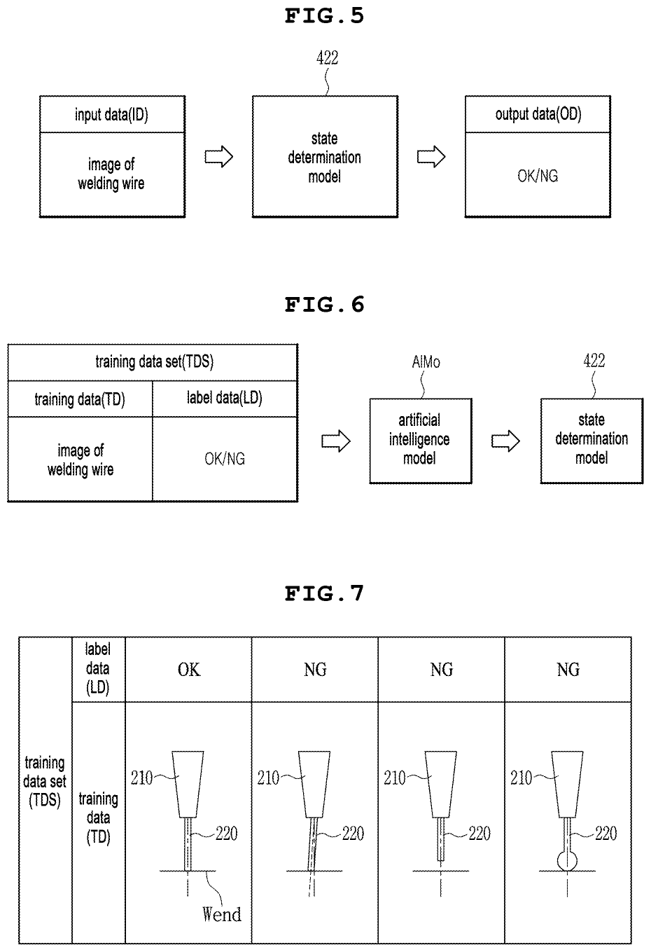

FIG. 4 is a view illustrating a controller including a state determination model in a laser wire welding apparatus according to an exemplary embodiment, FIG. 5 is a view illustrating a usage state of a state determination model in a laser wire welding apparatus according to an exemplary embodiment, FIG. 6 is a view illustrating a process of generating a state determination model in a laser wire welding apparatus according to an exemplary embodiment, and FIG. 7 is a view illustrating a training data set used for generating a state determination model in a laser wire welding apparatus according to an exemplary embodiment. FIG. 1 is referred to together.

Referring to FIGS. 1 and 4 to 7, in the present disclosure, the controller 400 may input the image of the welding wire received from the camera 300 into the state determination model 422, the state determination model 422 may determine the cutting state of the welding wire 220 as acceptable or defective, and the state determination model 422 may be an artificial intelligence model trained using a training data set (TDS) in which the image of the welding wire is the training data (TD) and acceptable (OK) or defective (NG) determinations are the label data (LD).

The controller 400 may include a processor 410 and a storage unit 420 communicatively connected to the processor 410 to transmit and receive data. The storage unit 420 may store the state determination model 422 for determining the cutting state of the welding wire 220 as acceptable (OK) or defective (NG). The storage unit 420 may store a program code written to determine the cutting state of the welding wire 220 as acceptable or defective, and other necessary data. The processor 410 may be operated by the program code stored in the storage unit 420 and may read and execute the state determination model 422. The controller 400 may further include a communication interface 430 for communication and an input/output interface 440 for input/output of data.

As illustrated in FIG. 6, the state determination model 422 may be generated by training an artificial intelligence model (AIMo) using a training data set (TDS) in which the images of the welding wire are training data (TD) and acceptable (OK) or defective (NG) determinations are label data (LD). When the image of the welding wire is input, the state determination model 422 may determine and output the cutting state of the welding wire 220 as acceptable (OK) or defective (NG).

In this case, as illustrated in FIG. 7, acceptable images of the welding wires and defective images of welding wires may be used as the training data (TD). The acceptable images of the welding wires may satisfy all of the inclination, the length, and the diameter of the welding wire 220. The defective images of the welding wire may be images in which at least one of the inclination, the length, and the diameter of the welding wire 220 is defective. The label data (LD) may be an acceptable (OK) or defective (NG) determination for the image of the welding wire 220.

When the state determination model 422 determines the cutting state of the welding wire 220 to be acceptable (OK), the controller 400 may control the welding robot 100 to perform the welding process.

When the state determination model 422 determines the cutting state of the welding wire 220 to be defective (NG), the controller 400 may control the welding robot 100 to perform the cutting process of the welding wire 220.

As described above, the welding process and the cutting process may be controlled to have different intensities and irradiation times in laser output.

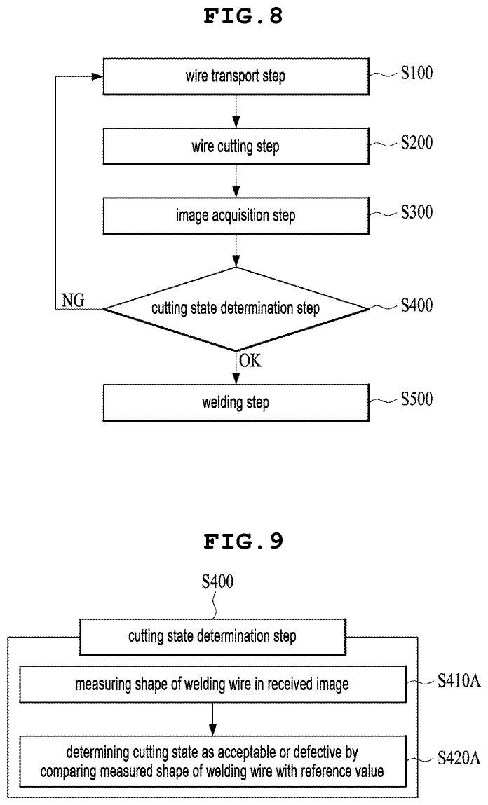

FIG. 8 is a view illustrating a laser wire welding method according to an exemplary embodiment. FIG. 1 is referred to together.

Referring to FIGS. 1 and 8, a laser wire welding method according to the present disclosure may include (S100) transporting a welding wire 220 to protrude by a predetermined length from an end of a wire tip 210 by driving a wire feeder 200, (S200) cutting the welding wire 220 by a welding robot 100 outputting a laser, (S300) acquiring an image by a camera 300 capturing the welding wire 220 on which laser cutting is performed, (S400) determining, a controller 400, an cutting state of the welding wire 220 as acceptable or defective on the basis of the image after receiving the image of the welding wire from the camera 300, and (S500) controlling, by the controller 400, the welding robot 100 to perform welding when the cutting state of the welding wire 220 is determined to be acceptable.

The wire transport step (S100) may be a step in which the controller 400 drives the wire feeder 200 and transports the welding wire 220 having a predetermined diameter. The end portion of the welding wire 220 may be transported to protrude by a predetermined length from the end of the wire tip 210.

The wire cutting step S200 may be a step in which the controller 400 controls the welding robot 100 to cut one side of the end portion of the welding wire 220 with laser output. The wire cutting step S200 may be a step of managing the quality of the end of the welding wire 220 uniformly.

In the wire cutting step S200, the controller 400 may control the welding robot 100 to adjust the laser output of the laser output device 130. The laser output may be differently adjusted depending on a material, a diameter, and a welding method of the welding wire 220. In order to secure the cutting quality of the welding wire 220, the laser output may be controlled to have an intensity of 1 kW to 4 kW and an irradiation time of 0.5 seconds or less. The welding wire 220 may be cut by instantaneously melting and vaporizing the cutting portion of the welding wire 220 through the laser output.

For quality control at the end of the welding wire 220, the controller 400 may control the laser output device 130 to adjust a laser intensity and an irradiation time according to a material, a diameter, and a welding method of the welding wire 220 when performing laser cutting.

At this time, parameters and cutting conditions for performing laser cutting of the welding wire 220 may be the same as described above, and thus may be applied.

The image acquisition step (S300) may be a step in which the camera 300 acquires an image by capturing the welding wire 220 on which the laser cutting is performed through the wire cutting step (S200).

In the image acquisition step (S300), the image of the welding wire captured and acquired by the camera 300 may be transmitted to the controller 400.

The cutting state determination step (S400) may be a step in which the controller 400 receives the images of the welding wire transmitted from the camera 300 and determines the cutting state of the welding wire 220 as acceptable (OK) or defective (NG) on the basis of the received image of the welding wire.

When the controller 400 determines the cutting state of the welding wire 220 to be acceptable (OK) in the cutting state determination step (S400), the welding step (S500) may be performed.

When it is determined to be defective in the cutting state determination step (S400), a step of feeding back to the wire transport step (S100) may be included.

That is, when the controller 400 determines the cutting state of the welding wire 220 to be defective (NG) in the cutting state determination step (S400), cutting of the welding wire 220 may be re-performed to recheck the cutting state, and such operations may be repeatedly performed.

The quality of the end of the welding wire 220 that comes into contact with the target 1 to be welded may be uniformly managed through feedback control in the cutting state determination step (S400).

When the controller 400 determines the cutting state of the welding wire 220 to be acceptable (OK) in the cutting state determination step (S400), the welding step (S500) may be a step in which welding on the target 1 to be welded is performed through laser output together with contact with the end of the welding wire 220.

Accordingly, in the present disclosure, a single laser output from the welding robot 100 may be used to perform non-contact cutting of the welding wire in addition to performing welding. In the present invention, the end of the welding wire may be uniformly managed. In the present disclosure, welding quality may be uniformly secured.

FIG. 9 is a view illustrating a cutting state determination step in a laser wire welding method according to an exemplary embodiment. FIGS. 1 to 3 are referred to together.

Referring to FIGS. 1 to 3 and 9, in the present disclosure, the cutting state determination step (S400) may include (S410A) measuring the shape of the welding wire 220 in the received image of the welding wire, and (S420A) determining the cutting state of the welding wire 220 as acceptable (OK) or defective (NG) by comparing the measured shape of the welding wire 220 with a preset reference value, and the shape of the welding wire 220 may include at least one of an inclination (θ), a length (L), and a diameter (D) of the welding wire 220.

In the step (S410A) of measuring the shape of the welding wire 220, the controller 400 may measure at least one of an inclination (θ), a length (L), and a diameter (D) of the welding wire (220) from the image of the welding wire. The controller 400 may measure each of the inclination (θ), the length (L), and the diameter (D) of the welding wire (220).

Referring to FIG. 3, the length (L) of the welding wire 220, which is a distance extending from the end (Tend) of the wire tip 210 to the end (Wend) of the welding wire 220 in contact with the target 1 to be welded, may be measured. The inclination (θ) of the welding wire 220, which is an angle formed between the centerline (Tc) of the diameter (TD) of the wire tip 210 and the line (WDc) connecting the center of the diameter (D) of the welding wire 220 to the center of the end of the wire tip 210, may be measured. The diameter (D) of the welding wire 220, which is an upper limit of the distance between two points passing through the center, may be measured.

In the step (S420A) of determining the cutting state of the welding wire 220 as acceptable (OK) or defective (NG), the controller 400 may measure at least one of the inclination (θ), the length (L), and the diameter (D) with respect to the end of the welding wire 220 and compare each measured value with a preset reference value. When each measured value is greater than the reference value, the controller 400 may determine the cutting state of the welding wire 220 to be acceptable (OK). When each measured value is less than the reference value, the controller 400 may determine the cutting state of the welding wire 220 to be defective (NG).

Accordingly, in the present disclosure, the cutting state of the end of the welding wire 220 in contact with the target 1 to be welded may be checked on the basis of the image of the welding wire. In the present disclosure, the quality of the end of the welding wire 220 can be managed.

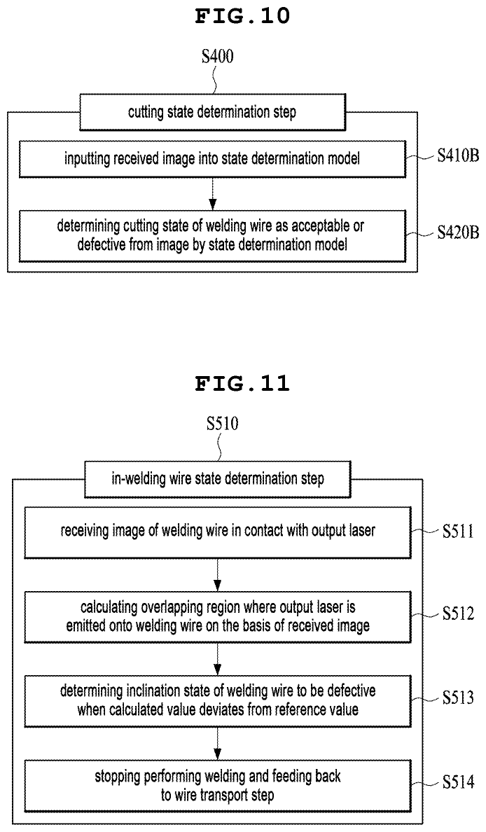

FIG. 10 is a view illustrating a cutting state determination step using a state determination model in a laser wire welding method according to an exemplary embodiment. FIGS. 1 and 4 to 7 are referred to together.

Referring to FIGS. 1, 4 to 7, and 10, in the present disclosure, the cutting state determination step (S400) may include (S410B) inputting the received image of the welding wire into the state determination model 422 by the controller 400, and (S420B) determining the cutting state of the welding wire 220 as acceptable or defective from the image by the state determination model 422, and the state determination model 422 may be an artificial intelligence model trained using a training data set (TDS) in which the image of the welding wire is the training data (TD) and acceptable or defective determinations are label data (LD).

In the step (S410B) of inputting the received image of the welding wire to the state determination model 422 by the controller 400, the controller 400 may receive the image of the welding wire transmitted from the camera 300 and input the transmitted image to the state determination model 422.

In the step (S420B) of determining the cutting state of the welding wire 220 as acceptable or defective by the state determination model 422 on the basis of the image, the state determination model 422 may determine and output the cutting state of the welding wire 220 as acceptable (OK) or defective (NG) on the basis of the received image of the welding wire.

Accordingly, in the present disclosure, it is possible to quickly and efficiently check the cutting state of the end of the welding wire 220 in contact with the target 1 to be welded by using artificial intelligence (AI). In the present disclosure, the quality of the end of the welding wire 220 may be managed.

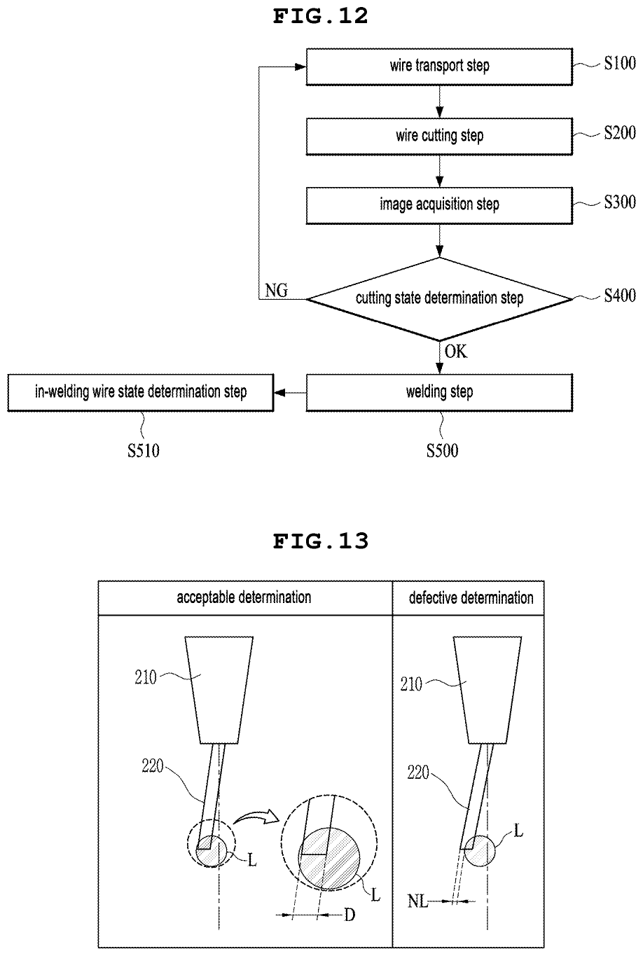

FIG. 11 is a view including an in-welding wire state determination step in a laser wire welding method according to an exemplary embodiment, FIG. 12 is a view illustrating an in-welding wire state determination step in a laser wire welding method according to an exemplary embodiment, and FIG. 13 is a view illustrating an acceptable or defective determination in an in-welding wire state determination step in a laser wire welding method according to an exemplary embodiment. FIG. 1 is referred to together.

Referring to FIGS. 1 and 11 to 13, the laser wire welding method according to the present disclosure may further include (S510) determining the state of the welding wire 220 while performing the welding step S500, and the in-welding wire state determination step (S510) may include (S511) receiving, by the controller 400, an image of the welding wire in contact with the output laser (L) from the camera 300 while performing welding, (S512) calculating, by the controller 400, an overlapping region where the output laser (L) is emitted onto the welding wire 220 on the basis of the received image of the welding wire, (S513) determining, by the controller 400, the state of the welding wire 220 to be defective when the calculated value of the overlapping region where the output laser (L) is emitted onto the welding wire 220 deviates from the reference value, and (S514) stopping performing the welding and feeding back to the wire transport step (S100) by the controller 400.

In the welding step (S500), welding may be performed by outputting a laser from the laser output device 130 of the welding robot 100 while the end of the welding wire 220 is in contact with the target 1 to be welded.

As illustrated in FIG. 13, in the step (S511) of receiving, by the controller 400, the image of the welding wire in contact with the output laser (L) from the camera 300 while performing welding, an image may be obtained by capturing, by the camera 300, an region of an end portion of the welding wire 220 in contact with the output laser (L). The camera 300 may transmit the image of the welding wire to the controller 400, and the controller 400 may receive the image of the welding wire.

In the step (S512) of calculating, by the controller 400, an overlapping region where the output laser (L) is emitted onto the welding wire 220 on the basis of the received image of the welding wire, a degree of the area where the output laser (L) overlaps may be calculated on the basis of the diameter (D) of the welding wire 220. A degree of the area (NL) not overlapping each other between the output laser (L) and the welding wire 220 may be calculated on the basis of the diameter (D) of the welding wire 220.

In the step (S513) of determining, by the controller 400, the state of the welding wire 220 to be defective when the calculated value of the overlapping region where the output laser (L) is emitted onto the welding wire 220 deviates from the reference value, the reference value may be 95% of the diameter (D) of the welding wire 220. Referring to FIG. 13, when the overlapping region where the output laser (L) is emitted onto the welding wire 220 is equal to or greater than 95% of the diameter (D) of the welding wire 220, it may be determined to be acceptable (OK). When the overlapping region where the output laser (L) is emitted onto the welding wire 220 is less than 95% of the diameter (D) of the welding wire 220, it may be determined to be defective (NG). Sometimes, when the region (NL) not overlapping each other between the output laser (L) and the welding wire 220 is 5% or more on the basis of the diameter (D) of the welding wire 220, it may be determined to be defective (NG). The shape of the welding wire 220 may be determined to be defective based on the inclination (θ) or length (L).

In this case, the numerical value representing the reference value may be described by way of an example to help understanding, and may not be particularly limited thereto, and may be modified or changed.

In the step (S514) of stopping performing welding and feeding back to the wire transport step (S100) by the controller 400, the state of the end portion of the welding wire 220 may be checked while the welding is performed, but when the state of the welding wire 220 is determined to be defective, the controller 400 may stop performing welding and feedback to the wire transport step (S100). The cutting process of the welding wire 220 may be performed again.

Accordingly, in the present disclosure, the state of the welding wire 220 may be checked even while welding is being performed, and the quality of the end of the welding wire 220 may be managed. In the present disclosure, welding quality may be uniformly secured.

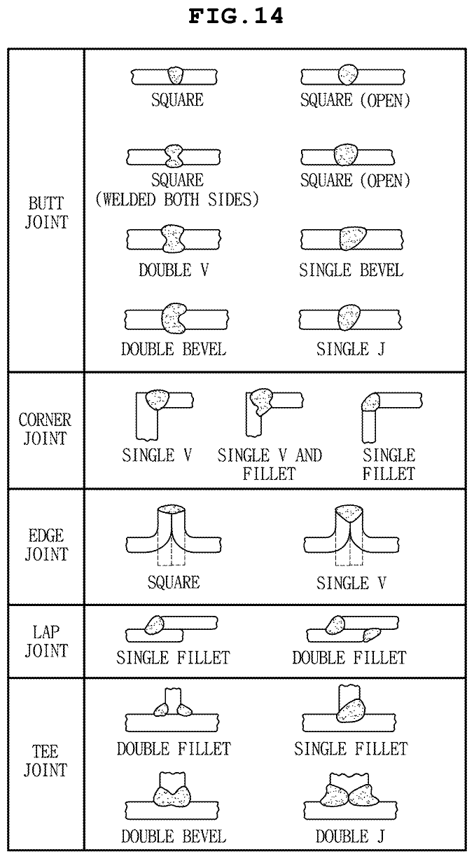

FIG. 14 is a view illustrating a design shape of welding that can be performed through a laser wire welding apparatus and method according to an exemplary embodiment.

Referring to FIG. 14, the apparatus and method for the laser wire welding according to the present disclosure can perform welding such as a butt joint, a corner joint, an edge joint, a lap joint, and a tee joint.

The butt joint may be subdivided into a square type, a single V type, a double V type, a single bevel type, a double bevel type, and a single J type for welding.

The corner joint may be subdivided into a single V type, a single fillet type, and a combined type of a single V and a single fillet for welding.

The edge joint may be subdivided into a square type and a single V type for welding.

The Lap joint may be subdivided into a single fillet type and a double fillet type for welding.

The Tee joint may be subdivided into a double fillet type, a single bevel type, a double bevel type, and a double J type for welding.

The present disclosure has been described in detail through specific exemplary embodiments. The foregoing description is merely illustrative of principles of the present disclosure, and other components may be further included or substituted with other components within a range not departing from the scope of the present disclosure.

What is claimed is:

1. An apparatus for laser wire welding, the apparatus comprising:
a welding robot movable and outputting a laser for performing cutting of a welding wire in addition to performing welding of a target to be welded;
a wire feeder for transporting and supplying the welding wire, which is melted by the laser supplied by the welding robot to enable welding at a welding portion of the target to be welded, to protrude by a predetermined length from an end of a wire tip;
a camera for acquiring an image of the welding wire; and
a controller for receiving the image of the welding wire from the camera, for determining a cutting state of the welding wire on the basis of the image, and for controlling the welding robot to perform welding when the cutting state of the welding wire is determined to be acceptable.

2. The apparatus of claim 1, wherein the controller controls the welding robot to perform cutting when the cutting state of the welding wire is determined to be defective.

3. The apparatus of claim 1, wherein the welding robot comprises:
a movable body configured to be movable;
a multi-joint robot arm coupled to the movable body; and
a laser output device coupled to an end of the multi-joint robot arm and outputting the laser for performing welding of the target to be welded or for performing cutting of the welding wire.

4. The apparatus of claim 3, wherein the laser output device is controlled to have a lower laser intensity and a shorter laser irradiation time when performing cutting of the welding wire than when outputting the laser for performing welding.

5. The apparatus of claim 1, wherein the controller measures a shape of the welding wire from the image of the welding wire received from the camera, and determines the cutting state of the welding wire as acceptable or defective by comparing the measured shape with a preset reference value.

6. The apparatus of claim 1, wherein the controller inputs the image of the welding wire received from the camera into a state determination model, and the state determination model determines the cutting state of the welding wire as acceptable or defective,
wherein the state determination model is an artificial intelligence model trained using a training data set in which the images of the welding wire are training data and acceptable or defective determinations are label data.

7. The apparatus of claim 5, wherein the shape of the welding wire comprises at least one of an inclination, a length, and a diameter of the welding wire.

8. The apparatus of claim 7, wherein the length of the welding wire is a distance from the end of the wire tip to the end of the welding wire in contact with the target to be welded,
the inclination of the welding wire is an angle formed between a centerline of a diameter of the wire tip and a line connecting a center of the diameter of the welding wire to a center of the end of the wire tip, and
the diameter of the welding wire is a straight line passing through a center of a circle, which is an upper limit of a length of a line segment connecting two points on the circumference.

9. A method for laser wire welding, the method comprising:
transporting a welding wire to protrude by a predetermined length from an end of a wire tip by driving a wire feeder;
cutting the welding wire by a welding robot outputting a laser;
acquiring an image by a camera capturing the welding wire on which laser cutting is performed;
determining, by a controller, an cutting state of the welding wire as acceptable or defective on the basis of the image after receiving the image of the welding wire from the camera; and
controlling, by the controller, the welding robot to perform welding when the cutting state of the welding wire is determined to be acceptable.

10. The method of claim 9, further comprising:
feeding back to the wire transport step when it is determined to be defective in the cutting state determination step.

11. The method of claim 9, wherein the cutting state determination step comprises:
measuring a shape of the welding wire in the received image of the welding wire; and
determining the cutting state of the welding wire as acceptable or defective by comparing the measured shape of the welding wire with a preset reference value,
wherein the shape of the welding wire comprises at least one of an inclination, a length, and a diameter of the welding wire.

12. The method of claim 9, wherein the cutting state determination step comprises:
inputting the received image of the welding wire into a state determination model by the controller; and
determining the cutting state of the welding wire as acceptable or defective by the state determination model on the basis of the image,
wherein the state determination model is an artificial intelligence model trained using a training data set in which the images of the welding wire are training data and acceptable/defective determinations are label data.

13. The method of claim 9, further comprising:
determining a state of the welding wire while performing the welding step,
wherein the in-welding wire state determination step comprises:
receiving, by the controller, the image of the welding wire, which is in contact with an output laser, from the camera while welding is being performed;
calculating, by the controller, an overlapping region in which the output laser is emitted onto the welding wire on the basis of the received image;
determining, by the controller, the state of the welding wire as defective when the calculated value of the overlapping region in which the output laser is emitted onto the welding wire deviates from a reference value; and
stopping performing welding by the controller to feedback to the wire transport step.
